(19) United States
(12) Patent Application Publication
(10) Pub. No.: US 2008/0198101 A1
(43) Pub. Date: Aug. 21, 2008

(54) PLASMA DISPLAY APPARATUS AND METHOD OF DRIVING THE SAME

(76) Inventors: Byungsoo Song, Seoul (KR); Junghwan Kim, Seoul (KR); Taeok Ha, Seoul (KR); Seonghak Moon, Seoul (KR); Seungchan Baek, Seoul (KR)

Correspondence Address: KED & ASSOCIATES, LLP, P.O. Box 221200, Chantilly, VA, 20153-1200, US

(21) Appl. No.: 12/034,356

(22) Filed: Feb. 20, 2008

(30) Foreign Application Priority Data
Feb. 20, 2007 (KR) 10-2007-0017193

(51) Int. Cl. G09G 3/28

(52) U.S. Cl. 345/63

(57) ABSTRACT

A plasma display apparatus and a method of driving the same are disclosed. In the method, the number of sustain signals assigned to at least one of a plurality of subfields of a frame is different from the number of sustain signals assigned to the other subfields depending on an average power level (APL) of the frame. The number of sustain signals assigned depending on the APL is additionally adjusted in relation to a maximum gray level of the frame.

This application claims the benefit of Korean Patent Application No. 10-2007-0017193 filed on Feb. 20, 2007 which is hereby incorporated by reference.

### BACKGROUND

1. Field

An exemplary embodiment relates to a plasma display apparatus and a method of driving the same.

2. Description of the Related Art

A plasma display apparatus includes a plasma display panel and a driver.

The plasma display panel includes a phosphor layer inside discharge cells partitioned by barrier ribs and a plurality of electrodes.

A driving signal is supplied to the electrodes, thereby generating a discharge inside the discharge cells. When the driving signal generates the discharge inside the discharge cells, a discharge gas filled inside the discharge cells generates vacuum ultraviolet rays, which thereby cause phosphors formed inside the discharge cells to emit light, thus displaying an image on the screen of the plasma display panel.

### SUMMARY OF THE DISCLOSURE

In one aspect, a method of driving a plasma display apparatus displaying an image in a frame including a plurality of subfields, the method comprises controlling the number of sustain signals assigned to at least one of the plurality of subfields of the frame to be different from the number of sustain signals assigned to the other subfields depending on an average power level (APL) of the frame, and additionally controlling the number of sustain signals assigned depending on the APL in relation to a maximum gray level of the frame.

In another aspect, a plasma display apparatus comprises a plasma display panel displaying an image in a plurality of frames each including a plurality of subfields, the plasma display panel including an electrode, and a driver supplying a sustain signal to the electrode, wherein the plurality of frames include a first frame and a second frame, an average power level (APL) of the first frame is substantially equal to an APL of the second frame, and a maximum gray level of the first frame is different from a maximum gray level of the second frame, and the total number of sustain signals supplied to the electrode in the first frame is different from the total number of sustain signals supplied to the electrode in the second frame.

In still another aspect, a plasma display apparatus comprises a plasma display panel displaying an image in a plurality of frames each including a plurality of subfields, the plasma display panel including an electrode, and a driver supplying a sustain signal to the electrode, wherein the plurality of frames include a first frame and a second frame, an average power level (APL) of the first frame is substantially equal to an APL of the second frame, and a maximum gray level of the first frame is different from a maximum gray level of the second frame, and in case that the maximum gray levels of the first and second frames are equal to or more than a critical gray level, a data signal is supplied to the electrode during address periods of all of subfields of the first frame at the maximum gray level of the first frame, and a data signal is supplied to the electrode during address periods of all of subfields of the second frame at the maximum gray level of the second frame.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 is a diagram showing a configuration of a plasma display apparatus according to an exemplary embodiment;

FIG. 2 is a diagram showing a structure of a plasma display panel according to the exemplary embodiment;

FIG. 3 shows a frame for achieving a gray level of an image in the plasma display apparatus;

FIG. 4 is a diagram showing a driving waveform of the plasma display panel;

FIG. 5 is a diagram for explaining an average power level (APL);

FIGS. 6A and 6B and FIGS. 7A and 7B are diagrams for explaining an example of a method of driving the plasma display apparatus;

FIG. 8 is a diagram for explaining another example of a method of driving the plasma display apparatus;

FIG. 9 is a diagram for explaining a reason to adjust the number of sustain signals in relation to a maximum gray level of a frame;

FIGS. 10A and 10B are diagrams for explaining a method of deciding a maximum gray level of a frame;

FIGS. 11A to 11C are diagrams for explaining an example of a method of adjusting the number of sustain signals in consideration of a critical gray level;

FIG. 12 is a diagram for explaining a method of driving the plasma display apparatus using a histogram;

FIG. 13 is a diagram for explaining a method of setting a maximum value of a histogram;

FIGS. 14 to 17 are diagrams for explaining in detail an example of a method of adjusting the number of sustain signals; and

FIG. 18 is a diagram showing in detail a configuration of the plasma display apparatus.

### DETAILED DESCRIPTION OF EMBODIMENTS

Reference will now be made in detail embodiments of the invention examples of which are illustrated in the accompanying drawings.

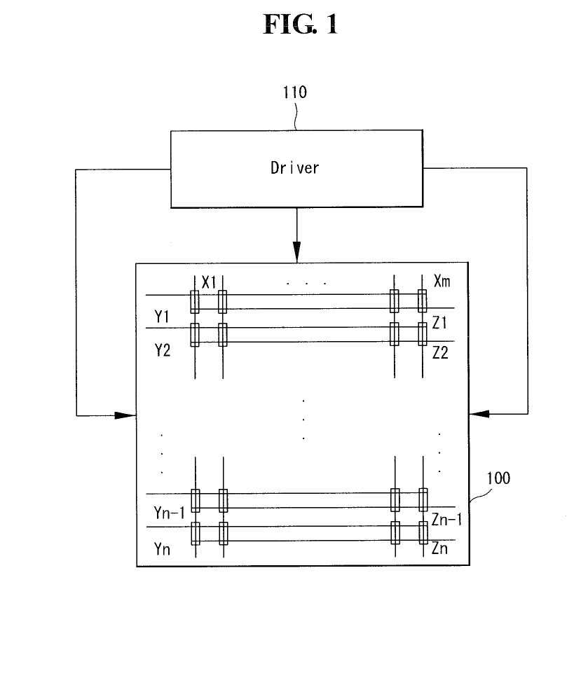

FIG. 1 is a diagram showing a configuration of a plasma display apparatus according to an exemplary embodiment.

As shown in FIG. 1, the plasma display apparatus according to the exemplary embodiment includes a plasma display panel 100 and a driver 110.

The plasma display panel 100 includes scan electrodes Y1-Yn and sustain electrodes Z1-Zn positioned parallel to each other, and address electrodes X1-Xm positioned to intersect the scan electrodes Y1-Yn and the sustain electrodes Z1-Zn.

The driver 110 supplies a driving signal to at least one of the scan electrode, the sustain electrode, or the address electrode to display thereby an image on the screen of the plasma display panel 100.

Although FIG. 1 has shown the case that the driver 110 is formed in the form of a signal board, the driver 110 may be formed in the form of a plurality of boards depending on the electrodes of the plasma display panel 100. For example, the driver 110 may include a first driver (not shown) for driving the scan electrodes Y1-Yn, a second driver (not shown) for driving the sustain electrodes Z1-Zn, and a third driver (not shown) for driving the address electrodes X1-Xm.

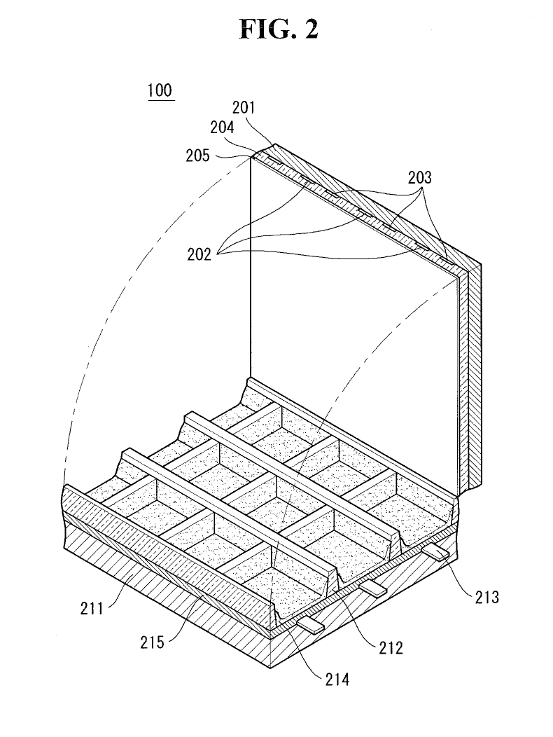

FIG. 2 is a diagram showing a structure of a plasma display panel according to the exemplary embodiment.

As shown in FIG. 2, the plasma display panel 100 may include a front substrate 201, on which a scan electrode 202 and a sustain electrode 203 are positioned parallel to each other, and a rear substrate 211 on which an address electrode 213 is positioned to intersect the scan electrode 202 and the sustain electrode 203.

An upper dielectric layer 204 may be positioned on the scan electrode 202 and the sustain electrode 203 to limit a discharge current of the scan electrode 202 and the sustain electrode 203 and to provide electrical insulation between the scan electrode 202 and the sustain electrode 203.

A protective layer 205 may be positioned on the upper dielectric layer 204 to facilitate discharge conditions. The protective layer 205 may include a material having a high secondary electron emission coefficient, for example, magnesium oxide (MgO).

A lower dielectric layer 215 may be positioned on the address electrode 213 to provide electrical insulation of the address electrodes 213.

Barrier ribs 212 of a stripe type, a well type, a delta type, a honeycomb type, and the like, may be positioned on the lower dielectric layer 215 to partition discharge spaces (i.e., discharge cells). Hence, a first discharge cell emitting red light, a second discharge cell emitting blue light, and a third discharge cell emitting green light, and the like, may be positioned between the front substrate 201 and the rear substrate 211.

Each of the discharge cells partitioned by the barrier ribs 212 may be filled with a discharge gas. The discharge gas may include xenon (Xe) and neon (Ne), and also may further include at least one of argon (Ar) and helium (He). As a Xe content of the discharge gas increases, a generation amount of visible light increases. Hence, a luminance of an image can be improved.

A phosphor layer 214 may be positioned inside the discharge cells to emit visible light for an image display during an address discharge. For instance, first, second, and third phosphor layers that produce red, blue, and green light, respectively, may be positioned inside the discharge cells.

The structure of the plasma display panel is not limited to the structure described in FIG. 2, and may be changed variously. For instance, a thickness of the second phosphor layer or the third phosphor layer may be larger than a thickness of the first phosphor layer. Further, although the upper dielectric layer 204 and the lower dielectric layer 215 each have a single-layered structure in FIG. 2, at least one of the upper dielectric layer 204 and the lower dielectric layer 215 may have a multi-layered structure.

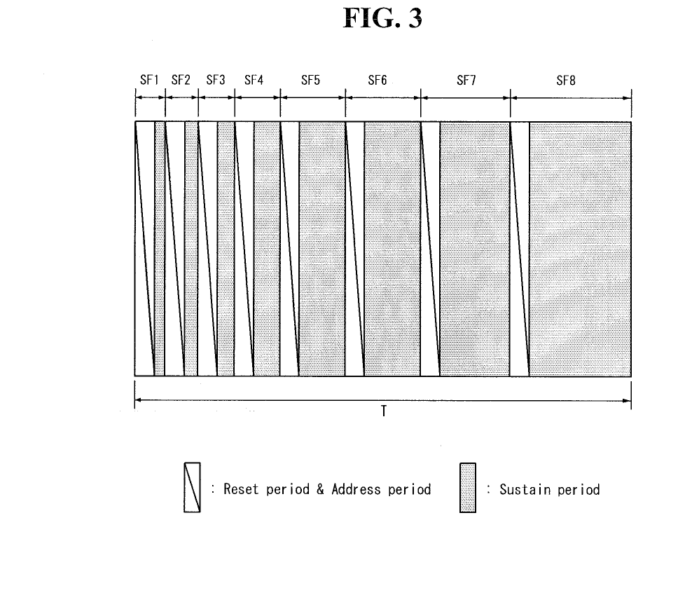

FIG. 3 shows a frame for achieving a gray level of an image in the plasma display apparatus.

As shown in FIG. 3, a frame for achieving a gray level of an image displayed by the plasma display may be divided into a plurality of subfields each having a different number of emission times.

Although it is not shown, at least one of the plurality of subfields may be subdivided into a reset period for initializing the discharge cells, an address period for selecting cells to be discharged, and a sustain period for representing gray level depending on the number of discharges.

For example, if an image with 256 gray levels is to be displayed, a frame, as shown in FIG. 3, is divided into 8 subfields SF1 to SF8. Each of the 8 subfields SF1 to SF8 is subdivided into a reset period, an address period, and a sustain period.

The number of sustain signals supplied during the sustain period determines a subfield weight of each subfield. For example, in such a method of setting a subfield weight of a first subfield SF1 at 2⁰ and a subfield weight of a second subfield at 2¹, a subfield weight of each subfield increases in a ratio of 2ⁿ (where, n=0, 1, 2, 3, 4, 5, 6, 7). Various images can be displayed by controlling the number of sustain signals supplied during a sustain period of each subfield depending on a subfield weight of each subfield.

Although FIG. 3 has shown and described the case where one frame includes 8 subfields, the number of subfields constituting one frame may vary. For example, one frame may include 10 subfields or 12 subfields.

Further, although FIG. 3 has illustrated and described the subfields arranged in increasing order of subfield weight, the subfields may be arranged in decreasing order of subfield weight, or the subfields may be arranged regardless of subfield weight.

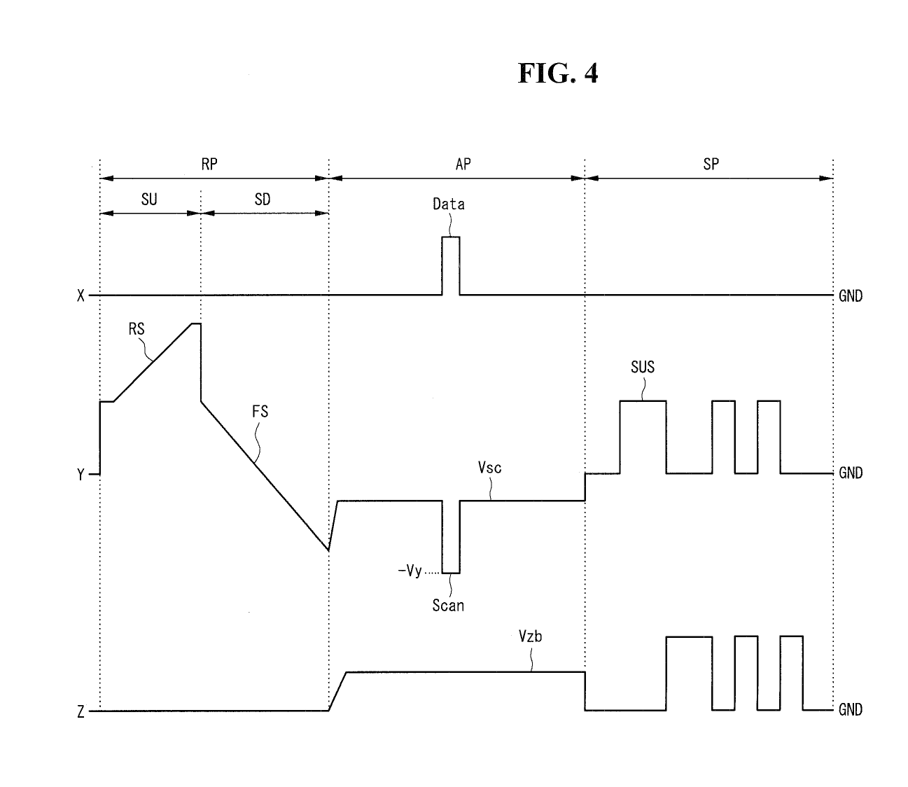

FIG. 4 is a diagram showing a driving waveform of the plasma display panel.

As shown in FIG. 4, a rising signal RS and a falling signal FS may be supplied to the scan electrode Y during a reset period RP for initialization of at least one subfield of a plurality of subfields of a frame. For instance, the rising signal RS may be supplied to the scan electrode Y during a setup period SU of the reset period RP, and the falling signal FS may be supplied to the scan electrode Y during a set-down period SD following the setup period SU.

When the rising signal RS is supplied to the scan electrode Y, a weak dark discharge (i.e., a setup discharge) occurs inside the discharge cell due to the rising signal RS. Hence, the remaining wall charges can be uniformly distributed inside the discharge cell.

When the falling signal FS is supplied to the scan electrode Y after the supply of the rising signal RS, a weak erase discharge (i.e., a set-down discharge) occurs inside the discharge cell. Hence, the remaining wall charges can be uniformly distributed inside the discharge cells to the extent that an address discharge occurs stably.

During an address period AP following the reset period RP, a scan bias signal Vsc having a voltage higher than a lowest voltage of the falling signal FS may be supplied to the scan electrode Y. A scan signal Scan falling from the scan bias signal Vsc may be supplied to the scan electrode Y during the address period AP.

A width of a scan signal supplied to the scan electrode during an address period of at least one subfield may be different from widths of scan signals supplied during address periods of the other subfields. For instance, a width of a scan signal in a subfield may be larger than a width of a scan signal in a next subfield in time order. A width of a scan signal may be gradually reduced in the order of 2.6 μs, 2.3 μs, 2.1 μs, 1.9 μs, etc., or may be reduced in the order of 2.6 μs, 2.3 μs, 2.3 μs, 2.1 μs, . . . , 1.9 μs, 1.9 μs, etc., in the successively arranged subfields.

When the scan signal Scan is supplied to the scan electrode Y, a data signal Data corresponding to the scan signal Scan may be supplied to the address electrode X.

As the voltage difference between the scan signal Scan and the data signal Data is added to a wall voltage by the wall charges produced during the reset period RP, an address discharge can occur inside the discharge cells to which the data signal Data is supplied.

During a sustain period SP following the address period AP, a sustain signal SUS may be supplied to at least one of the scan electrode Y or the sustain electrode Z. For instance, the sustain signal SUS may be alternately supplied to the scan electrode Y and the sustain electrode Z.

As the wall voltage inside the discharge cells selected by performing the address discharge is added to a sustain voltage of the sustain signal SUS, every time the sustain signal SUS is supplied, a sustain discharge (i.e., a display discharge) can occur between the scan electrode Y and the sustain electrode Z. Hence, an image can be displayed on the screen of the plasma display panel.

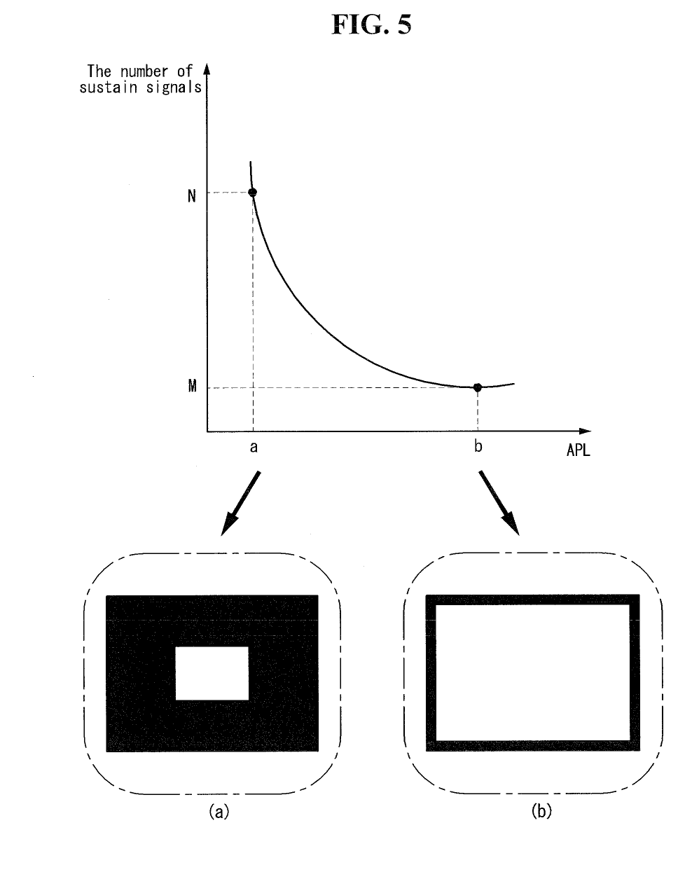

FIG. 5 is a graph showing a relationship between an average power level (APL) and the number of sustain signals in consideration of power consumption.

More specifically, when the power consumption increases, the number of sustain signals assigned to a frame decreases. When the power consumption decreases, the number of sustain signals assigned to a frame increases.

For instance, as shown in (a) of FIG. 5, in case that an image having a relatively small area is displayed on the screen of the plasma display panel, the power consumption may be relatively low because the APL may be relatively low, and thus the number of sustain signals assigned to a frame may increase. Hence, the entire luminance of the image can increase.

On the contrary, as shown in (b) of FIG. 5, in case that an image having a relatively large area is displayed on the screen of the plasma display panel, the power consumption may be relatively high because the APL may be relatively high, and thus the number of sustain signals assigned to a frame may decrease. Hence, an excessive increase in the power consumption can be prevented.

For instance, in case that the APL is a-level, the number of sustain signals assigned to a frame is N. In case that the APL is b-level higher than a-level, the number of sustain signals assigned to a frame is M smaller than N.

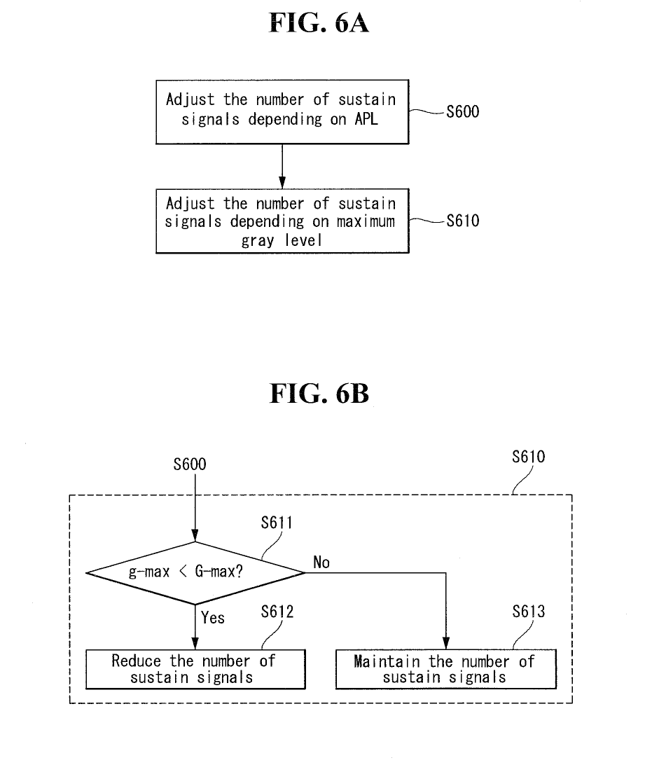

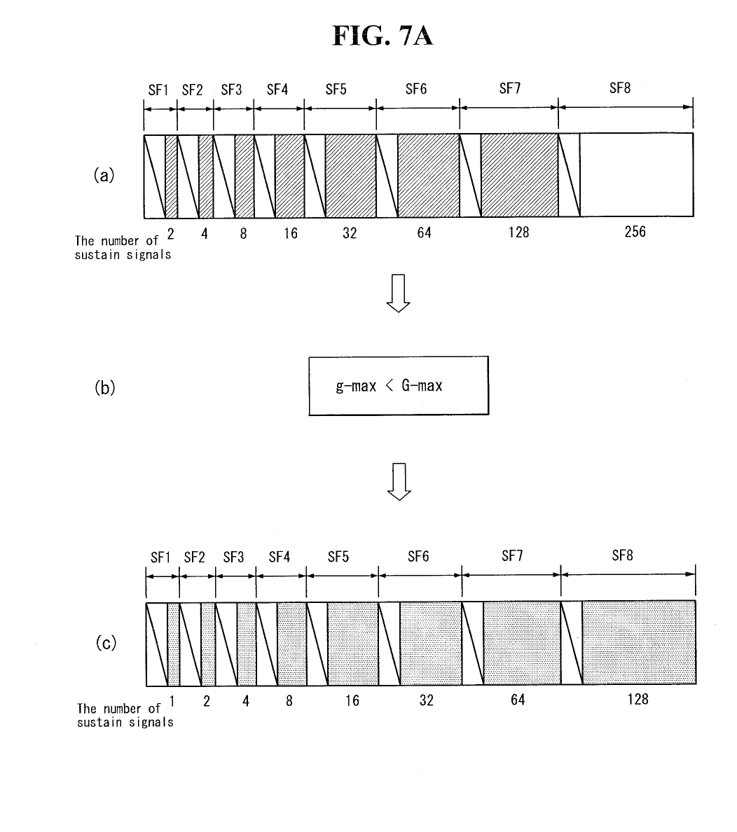

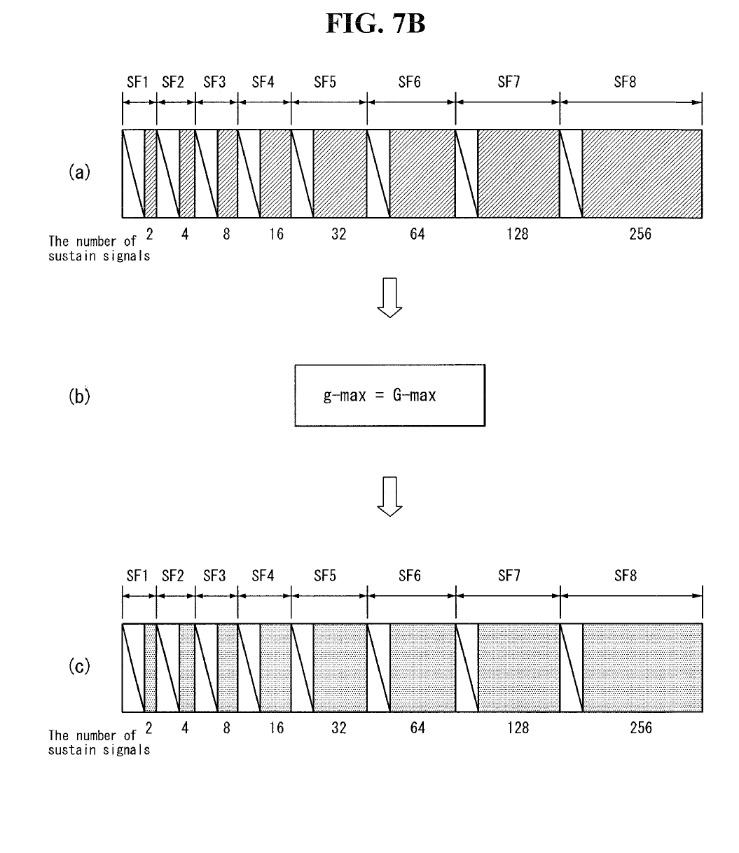

FIGS. 6A and 6B and FIGS. 7A and 7B are diagrams for explaining an example of a method of driving the plasma display apparatus.

As shown in FIG. 6A, a method of driving the plasma display apparatus may include step S600 of controlling the number of sustain signals assigned to at least one of a plurality of subfields of a frame to be different from the number of sustain signals assigned to the other subfields depending on an APL of the frame, and step S610 of additionally controlling the number of sustain signals assigned depending on the APL in relation to a maximum gray level g-max of the frame. In other words, the driving method of the plasma display apparatus adjusts the number of sustain signals assigned to at least one subfield depending on the APL of the frame, and then adjusts the number of sustain signals depending on the maximum gray level g-max of the frame.

FIG. 6B is a diagram for explaining in detail step S610 of FIG. 6A.

As shown in FIG. 6B, in step S611, it is decided whether the maximum gray level g-max of the frame is or is not smaller than a sum G-max of subfields weights of the plurality of subfields.

When the maximum gray level g-max of the frame is smaller than the sum G-max of the subfield weights, the number of sustain signals assigned depending on the APL is reduced in step S612.

When the maximum gray level g-max of the frame is substantially equal to than the sum G-max of the subfield weights, the number of sustain signals assigned depending on the APL is maintained without a change in step S613.

Because there is no case where the maximum gray level g-max of the frame is larger than the sum G-max of the subfield weights, it is not considered a case where the maximum gray level g-max of the frame is larger than the sum G-max of the subfield weights in step S611.

For instance, it is assumed that a video signal having an APL of 40 and a total of 512 sustain signals in a frame is input, and a maximum gray level of the video signal is 127. In this case, the number of sustain signals assigned to 8 subfields SF1 to SF8 of the frame, as shown in (a) of FIG. 7A, may be 2, 4, 8, 16, 32, 64, 128, and 256, respectively. Therefore, the maximum gray level (127 gray levels) of the frame may be achieved in (a) of FIG. 7A by turning on the first to seventh subfields SF1 to SF7 and turning off the eighth subfield SF8. A sum G-max of subfields weights of the 8 subfields SF1 to SF8 is 256, and a lowest subfield weight G-min of the frame may be 0 obtained by turning off the 8 subfields SF1 to SF8.

As shown in (b) of FIG. 7A, the maximum gray level g-max of the frame may be smaller than the sum G-max of the subfields weights of the 8 subfields SF1 to SF8 of the frame. Further, the maximum gray level g-max of the frame may lie in a range between the lowest subfield weight G-nin of the frame and the sum G-max of the subfield weights.

As shown in (c) of FIG. 7A, the number of sustain signals assigned to each of the 8 subfields SF1 to SF8 may be reduced to 1, 2, 4, 8, 16, 32, 64, and 128, respectively. Therefore, the maximum gray level (127 gray levels) of the frame may be achieved in (c) of FIG. 7A by turning on the first to eighth subfields SF1 to SF8. Although the number of turned-on subfields in (a) and (c) of FIG. 7A is different from each other, the number of sustain signals used in a sustain discharge in (a) and (c) of FIG. 7A is equal to each other. Accordingly, images displayed in (a) and (c) of FIG. 7A are equal to each other.

In (a) of FIG. 7A, the number of sustain signals assigned to at least one subfield is adjusted depending on an APL of a frame corresponding to an input video signal. In (c) of FIG. 7A, the number of sustain signals assigned to at least one subfield is adjusted depending on the APL, and then the number of sustain signals assigned to at least one subfield is again adjusted in relation to a maximum gray level of the frame.

More specifically, in (a) of FIG. 7A, an off-subfield (for example, the eighth subfield) exists in the frame. In other words, 256 sustain signals are assigned to the eighth subfield, but the 256 sustain signals are an ineffective sustain signal which does not generate a sustain discharge. Hence, the reactive power consumption may increase, and the power efficiency may worsen.

On the other hand, in (c) of FIG. 7A, all the subfields SF1 to SF8 of the frame are turned on by increasing a gain, and thus (c) of FIG. 7A can display the same image as (a) of FIG. 7A. Because the number of ineffective sustain signals is reduced in (c) of FIG. 7A, the power efficiency can be improved.

While the total number of sustain signals assigned to the frame in (a) of FIG. 7A is approximately 512, the total number of sustain signals assigned to the frame in (C) of FIG. 7A is approximately 256. The number of sustain signals is reduced in the ratio of g-max/G-max.

While the maximum gray level in (a) of FIG. 7A is approximately 127, the maximum gray level in (c) of FIG. 7A is approximately 256. The gain increases in the ratio of G-max/g-max.

In (a) of FIG. 7B, it is assumed that a video signal having an APL of 40 and a total of 512 sustain signals in a frame is input, and a maximum gray level of the video signal is 256. In this case, the number of sustain signals assigned to the 8 subfields SF1 to SF8, as shown in (a) of FIG. 7B, may be 2, 4, 8, 16, 32, 64, 128, and 256, respectively. Therefore, the maximum gray level (256 gray levels) of the frame may be achieved in (a) of FIG. 7B by turning on all the subfields SF1 to SF8.

As shown in (b) of FIG. 7B, a maximum gray level g-max of the frame may be substantially equal to a sum G-max of subfield weights of all the subfields. As shown in (c) of FIG. 7B, the number of sustain signals assigned to each subfield depending on the APL may be maintained without a change.

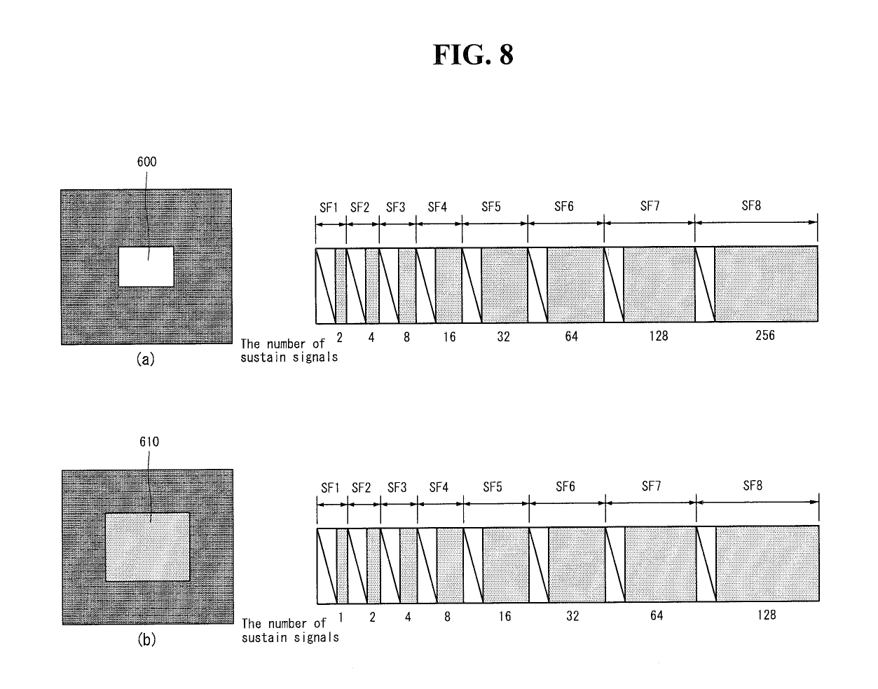

FIG. 8 is a diagram for explaining another example of a method of driving the plasma display apparatus.

As shown in FIG. 8, the total number of sustain signals supplied to the electrodes of the plasma display panel may be different from each other in two different frames having a substantially equal APL and different maximum gray levels. More specifically, as shown in (a) of FIG. 8, in case that an image 600 of a first frame having a relatively higher maximum gray level is displayed on the screen, the total number of sustain signals assigned to each subfield may be 512 (=2+4+8+16+32+64+128+256). As shown in (b) of FIG. 8, in case that an image 610 of a second frame having a relatively lower maximum gray level is displayed on the screen, the total number of sustain signals assigned to each subfield may be 265 (=1+2+4+8+16+32+64+128) less than (a) of FIG. 8.

In other words, although the two different first and second frames have the equal APL, the number of sustain signals assigned to the second frame having the relatively lower maximum gray level may be less than the number of sustain signals assigned to the first frame having the relatively higher maximum gray level.

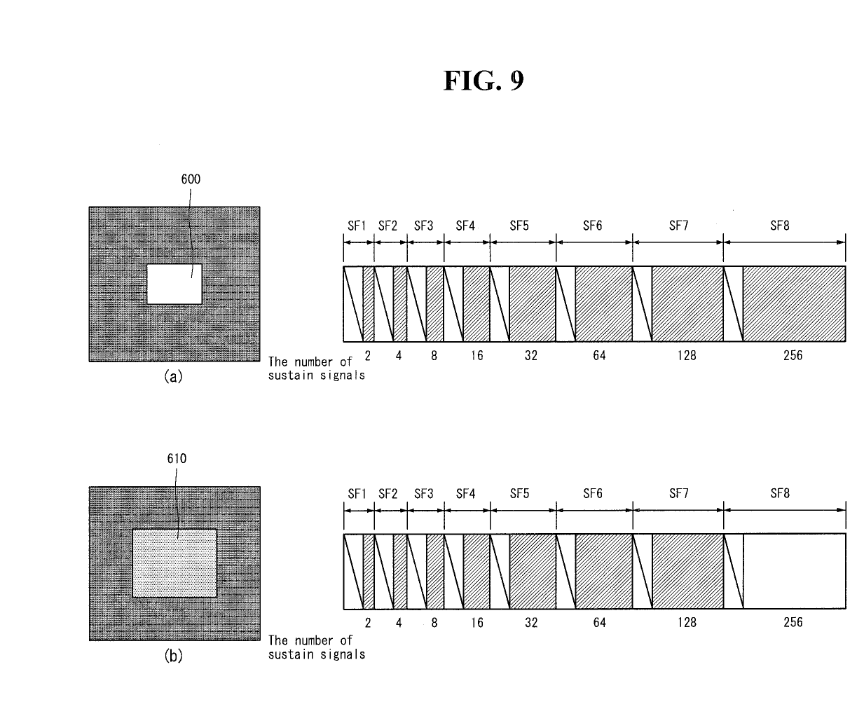

FIG. 9 is a diagram for explaining a reason to adjust the number of sustain signals in relation to a maximum gray level of a frame.

In FIG. 9, it is assumed that a frame includes a total of 8 subfields SF1 to SF8, the number of sustain signals assigned to the first to eighth subfields SF1 to SF8 are 2, 4, 8, 16, 32, 64, 128, 256, respectively, and the subfields SF1 to SF8 have a subfield weight of 2ⁿ (where, n=0, 1, 2, 3, 4, 5, 6, 7), respectively.

More specifically, as shown in (a) of FIG. 9, if the image 600 of the first frame has a gray level (i.e., 256 gray levels) corresponding to full-white, all the first to eighth subfields SF1 to SF8 have to be turned on. In other words, data signals are supplied to the address electrode during address periods of all the subfields SF1 to SF8.

As shown in (b) of FIG. 9, if the image 610 of the second frame has 128 gray levels lower than the gray level of the first frame, the first to seventh subfields SF1 to SF7 have to be turned on. In this case, because the eighth subfield SF8 to which 256 sustain signals are assigned is turned off, the 256 sustain signals of the eighth subfield SF8 become an ineffective sustain signal which does not generate a sustain discharge. Hence, reactive power consumption may increase, and the drive efficiency may be reduced.

On the other hand, as shown in (b) of FIG. 8, in case that the image 610 of the second frame having the relatively lower maximum gray level is displayed on the screen, the reactive power consumption can be reduced without a reduction in a luminance by reducing the total number of sustain signals.

More specifically, in case that the first to seventh subfields SF1 to SF7 are turned on as in (b) of FIG. 9, 254 sustain signals are used in the sustain discharge. In case that the first to eighth subfields SF1 to SF8 are turned on as in (b) of FIG. 8, 255 sustain signals are used in the sustain discharge. Because the number of sustain signals used in the case of (b) of FIG. 8 is approximately equal to the number of sustain signals used in the case of (b) of FIG. 9, a luminance in the case of (b) of FIG. 8 may be substantially equal to a luminance in the case of (b) of FIG. 9. Further, because all the subfields are turned on in (b) of FIG. 8, the reactive power consumption in (b) of FIG. 8 may be less than the reactive power consumption in (b) of FIG. 9.

It may be advantageous that all of subfields of each of two different frames are turned on at a maximum gray level of each of the two different frames having a substantially equal APL and different maximum gray levels. In other words, data signals may be supplied to the address electrodes during address periods of all the subfields of each of the two frames. For instance, an image can be displayed by turning on all the subfields of each of the first and second frames at a maximum gray level of each of the first and second frames having a substantially equal APL and different maximum gray levels as shown in 8. Because the total number of sustain signals used in the first frame is different from the total number of sustain signals used in the second frame, although all the subfields of each of the first and second frames are turned on, an image of the first frame is different from an image of the second frame.

When the images of the first and second frames are displayed by turning on all the subfields of each of the first and second frames, the number of ineffective sustain signals in the first and second frames can be reduced at a minimum. Hence, the power efficiency can be sufficiently improved.

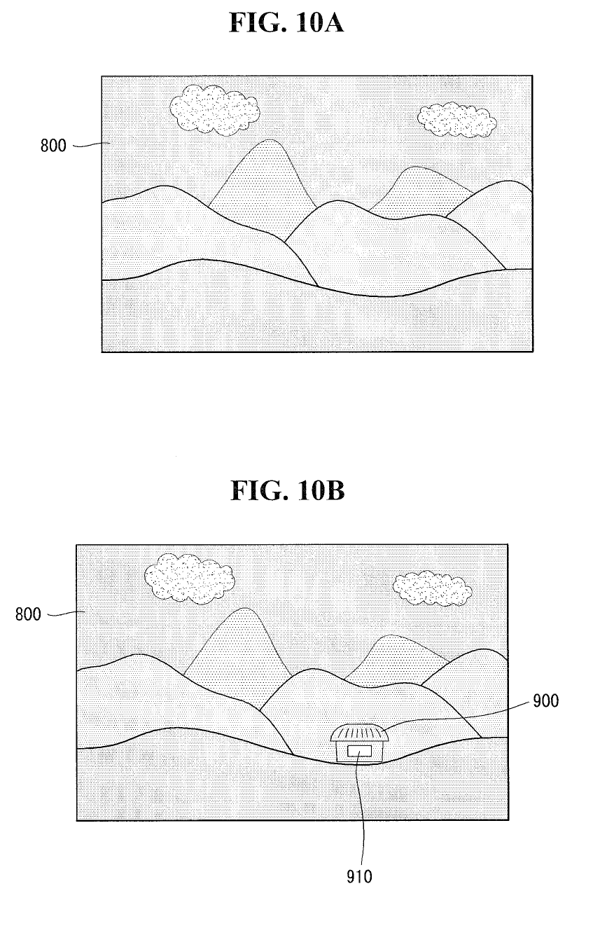

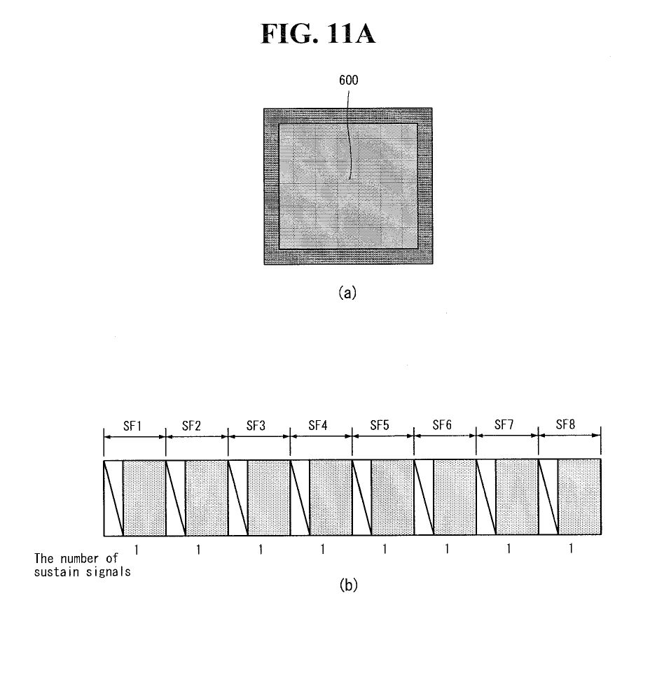

FIGS. 10A and 10B are diagrams for explaining a method of deciding a maximum gray level of a frame.

FIG. 10A shows an image of a night in the dark. For instance, a gray level of a sky 800 is highest, and a gray level of an object such as a mountain, a cloud may be lower than the gray level of the sky 800.

In this case, the gray level of the sky 800 may be decided as a maximum gray level of a corresponding frame. If maximum gray levels of two frames each displaying a different image are equal to each other, the number of sustain signals assigned to each of the two frames may be substantially equal to each other.

FIG. 10B shows an image in which a house 900 with a window 910 is added to the screen of FIG. 10A. If light comes from the window 910, a gray level of the window 910 may be excessively higher than the gray levels of the sky 800 and another object. For instance, the window 910 may have 255 gray levels, and the sky 800 may have 127 gray levels.

In case that the gray level of the window 910 is decided as a maximum gray level of a corresponding frame, the reactive power consumption may increase as in (b) of FIG. 9 because of the excessively high maximum gray level of the corresponding frame.

Accordingly, a maximum gray level of a frame may be decided in consideration of the frequency in use of the maximum gray level of the frame. It may be advantageous that a maximum gray level of a frame may be selectively set at a predetermined gray level lower than a maximum gray level of a plurality of gray levels of video data. For instance, in case that a maximum gray level of a frame is A-gray level and the frequency in use of A-gray level is equal to or less than a first critical value based on the frequency of each gray level of the frame, B-gray level lower than A-gray level may be decided as a maximum gray level of the frame.

It is assumed that in FIG. 10B, the window 910 has 255 gray levels, a maximum gray level of the remaining image except the window 910 is 127 gray levels (i.e., the gray level of the sky 800 is 127 gray levels), and the window 910 occupies approximately 0.005% of the entire screen. If a maximum gray level of the frame in FIG. 10B is decided as 255 gray levels, the reactive power increases. The maximum gray level of the frame may be set in a range between 127 gray levels and a predetermined gray level lower than 255 gray levels so as to prevent an increase in the reactive power.

It may be advantageous that the first critical value is set within a range which reduces the reactive power and does not worsen the image quality. For instance, in case that the first critical value is excessively small, the reactive power increases and the drive efficiency may be reduced. On the contrary, in case that the first critical value is excessively large, the image quality may worsen due to the distortion of the image. Considering this, the first critical value may lie substantially in a range between 0.01% and 5% or between 0.1% and 3% of a sum of the frequency of each gray level of the frame.

It is assumed that FIG. 10A shows an image of a second frame and FIG. 10B shows an image of a first frame. A gray level of the sky 800 may be a maximum gray level in the second frame, and a gray level of the window 910 may be a maximum gray level in the first frame. All of subfields of the first frame may be turned on at the gray level of the window 910, and all of subfields of the second frame may be turned on at the gray level of the sky 800. Hence, the number of ineffective sustain signals can be reduced to a minimum, and thus the drive efficiency can be improved.

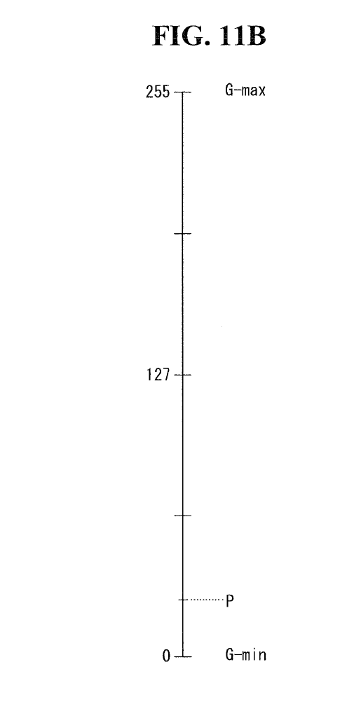

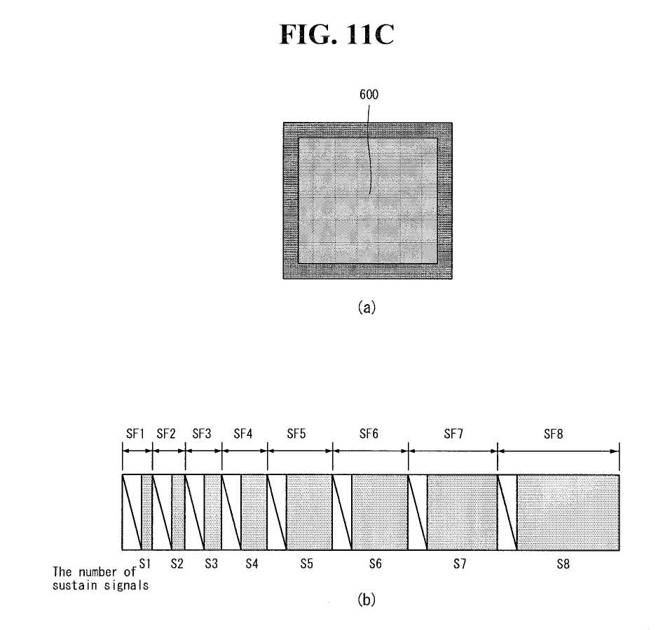

FIGS. 11A to 11C are diagrams for explaining an example of a method of adjusting the number of sustain signals in consideration of a critical gray level.

It is assumed that first and second frames have an equal APL, and maximum gray levels of the first and second frames are different from each other.

In case that the maximum gray levels of the first and second frames are equal to or more than a critical gray level, all of subfields of the first frame may be turned on at the maximum gray level of the first frame and all of subfields of the second frame may be turned on at the maximum gray level of the second frame. In other words, in case that a maximum gray level of a frame is a sufficiently high value equal to or more than a critical gray level, all of subfields of the frame may be turned on at the maximum gray level of the frame.

For instance, as shown in (a) of FIG. 11A, a frame in which an image with an excessively low gray level is displayed may have a very low maximum gray level. In this case, all of subfields of the frame may be turned on by greatly reducing the number of sustain signals assigned to each subfield of the frame as shown in (b) of FIG. 11A.

However, because a discharge may unstably occur in FIG. 11A, the image quality may worsen. Hence, when a maximum gray level of a frame is an excessively low value equal to or less than the critical gray level, the fact that all of subfields of the frame are turned on may be disadvantageous.

Accordingly, in case that the maximum gray levels of the first and second frames are equal to or more than the critical gray level, it may be advantageous that all the subfields of the first frame are turned on at the maximum gray level of the first frame and all the subfields of the second frame are turned on at the maximum gray level of the second frame.

When the critical gray level is set at an excessively large value, the number of ineffective sustain signals may increase and thus the drive efficiency may be reduced. On the contrary, when the critical gray level is set at an excessively small value, a discharge may unstably occur. Considering this, the critical gray level may lie substantially in a range between 1% and 25% from a lowest level of the entire gray level range. For instance, as shown in FIG. 11B, in a total of 256 gray levels having the entire gray level range of 0 (G-min) to 255 (G-max), a critical gray level P may be set in a range between 2.55 and 63.7. Since a gray level is indicated as a positive integer, the critical gray level P may be set in a range between 3 and 64 by rounding to one decimal place. Otherwise, the critical gray level P may be set in a range between 2.6 and 64 by rounding to the last decimal place so as to achieve a gray level with a decimal value.

In case that the maximum gray levels of the first and second frames are smaller than the critical gray level, it may be advantageous that the total number of sustain signals is maintained without a change so as to prevent a unstable discharge. In other words, in case that the maximum gray levels of the first and second frames are less than the critical gray level, the number of sustain signals in the first frame may be substantially equal to the number of sustain signals in the second frame.

In case that a maximum gray level of a frame is smaller than the critical gray level, the total number of sustain signals (=S1+S2+S3+S4+S5+S6+S7+S8) in the frame may be maintained at a predetermined level as shown in FIG. 11C.

It is assumed that the total number of sustain signals (=S1+S2+S3+S4+S5+S6+S7+S8) in the frame is indicated as S10, and the total number of sustain signals in the frame at a gray level corresponding to full-white is indicated as S20. In case that S10 is an excessively large value, the number of ineffective sustain signals increases. Hence, the drive efficiency may be reduced. On the contrary, in case that S10 is an excessively small value, a discharge may unstably occur. Considering this, it may be advantageous that S10 lies substantially in a range between 2% and 30% of S20.

For instance, it is assumed that a maximum gray level of the first frame is a gray level corresponding to substantially full-white, and a maximum gray level of the second frame is a gray level corresponding to substantially full-black. In this case, the total number of sustain signals in the second frame may lie substantially in a range between 2% and 30% of the total number of sustain signals in the first frame.

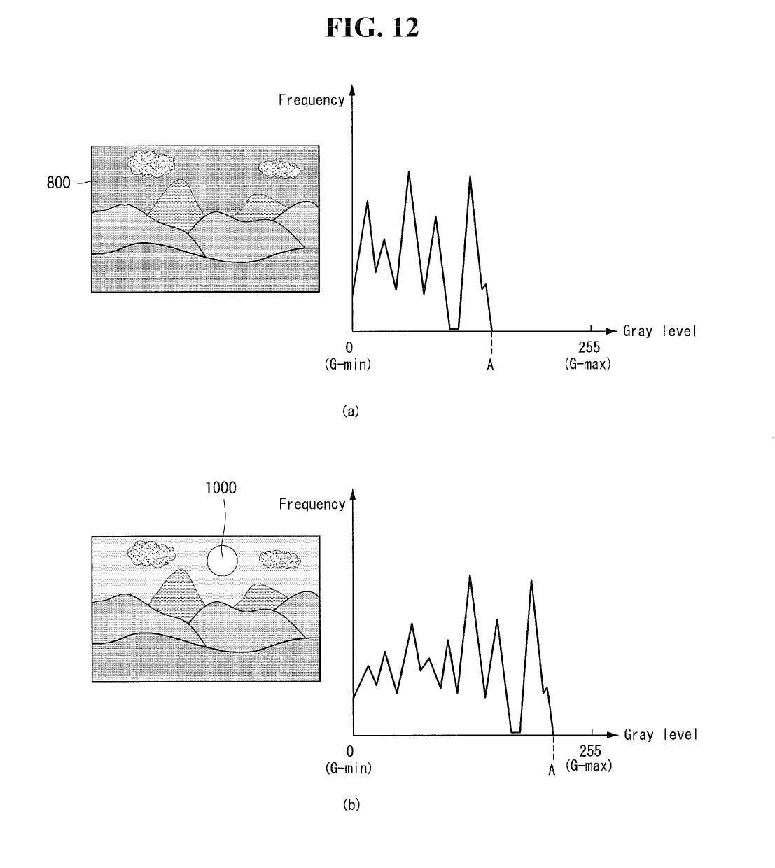

FIG. 12 is a diagram for explaining a method of driving the plasma display apparatus using a histogram.

In (a) of FIG. 12, a histogram of a frame of an image with a relatively low maximum gray level is shown in the right. In the histogram, X-axis indicates a gray level, and Y-axis indicates the frequency of a corresponding gray level.

In (a) of FIG. 12, the frame has the entire gray level range of 0 to “A”, and a maximum gray level A of the frame is a maximum value of the histogram. Further, a representable maximum gray level of the frame, i.e., a sum G-max of subfield weights of a plurality of subfields may be a possible effective value of the histogram. In other words, the effective value of the histogram may be 255.

Because a moon 1000 is added to an image of (b) of FIG. 12 as compared with an image of (a) of FIG. 12, a maximum gray level of the frame in (b) of FIG. 12 is higher than the maximum gray level of the frame in (a) of FIG. 12. In this case, a maximum value of the histogram in (b) of FIG. 12 is larger than a maximum value of the histogram in (a) of FIG. 12.

As above, when the maximum values of the histograms in (a) and (b) of FIG. 12 are different from each other, the number of sustain signals in (a) of FIG. 12 may be different from the number of sustain signals in (b) of FIG. 12. It may be advantageous that when the maximum value of the histogram in (a) of FIG. 12 is lower than the maximum value of the histogram in (b) of FIG. 12, the number of sustain signals in (a) of FIG. 12 is less than the number of sustain signals in (b) of FIG. 12.

Although an APL in (a) of FIG. 12 is substantially equal to an APL in (b) of FIG. 12, when the maximum value of the histogram in (a) of FIG. 12 is lower than the maximum value of the histogram in (b) of FIG. 12, the number of sustain signals in (a) of FIG. 12 may be less than the number of sustain signals in (b) of FIG. 12.

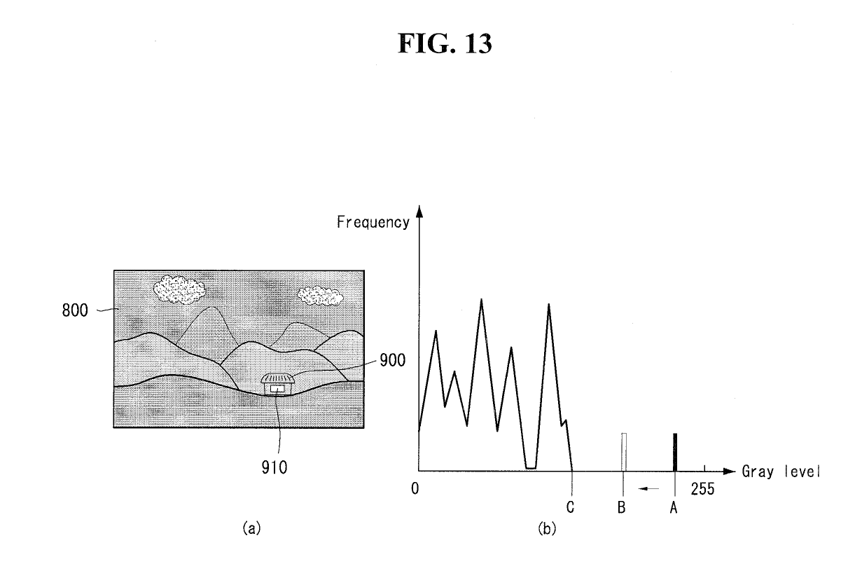

FIG. 13 is a diagram for explaining a method of setting a maximum value of a histogram.

As shown in FIG. 13, a maximum value of a histogram may be changed depending on the frequency of a maximum gray level in the histogram. In case that a maximum gray level of a frame is A and the frequency of A-gray level is equal to or less than a second critical value of the frequency of each gray level of the frame, a maximum value of the histogram of the frame may be B-gray level lower than A-gray level. The second critical value may lie substantially in a range between 0.01% and 5% based on the frequency of each gray level of the frame.

For instance, in (a) of FIG. 13, it is assumed that gray levels of a sky 800 and the other objects are relatively low and a gray level of a window 910 is excessively higher than the gray levels of the sky 800 and the other objects.

As shown in (b) of FIG. 13 showing a histogram of (a) of FIG. 13, the frequency of the gray levels of the sky 800 and the other objects in a range of 0 to C-gray level is sufficiently high and the frequency of the gray level (i.e., A-gray level) of the window 910 is very low.

If the gray level of the window 910 occupying a very small area of an image of (a) of FIG. 13 is set at a maximum value of the histogram, the number of turned-off subfields may increase. Hence, the reactive power consumption may increase. Therefore, the maximum value of the histogram may be set at B-gray level lower than A-gray level so as to reduce the reactive power consumption. B-gray level may be equal to or higher than C-gray level and lower than A-gray level.

It is assumed that there are first and second frames having a substantially equal APL and each having a different maximum value of a histogram. In case that the maximum value of the histogram of the first frame is a value corresponding to substantially full-white and the maximum value of the histogram of the second frame is a value corresponding to substantially full-black, the number of sustain signals in the second frame may lie in a range between 2% and 30% of the number of sustain signals in the first frame.

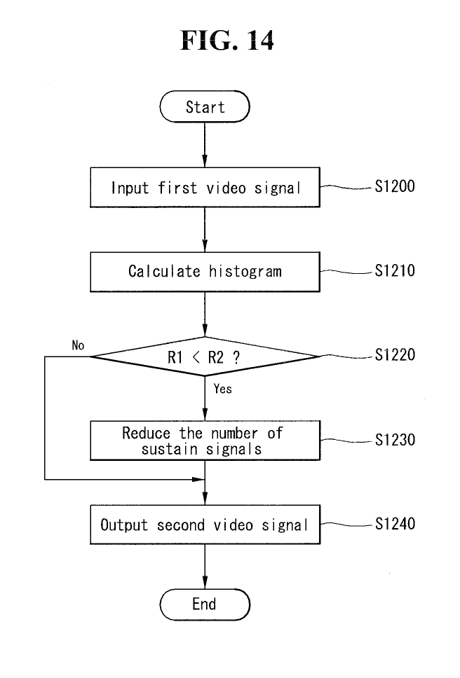

FIGS. 14 to 17 are diagrams for explaining in detail an example of a method of adjusting the number of sustain signals.

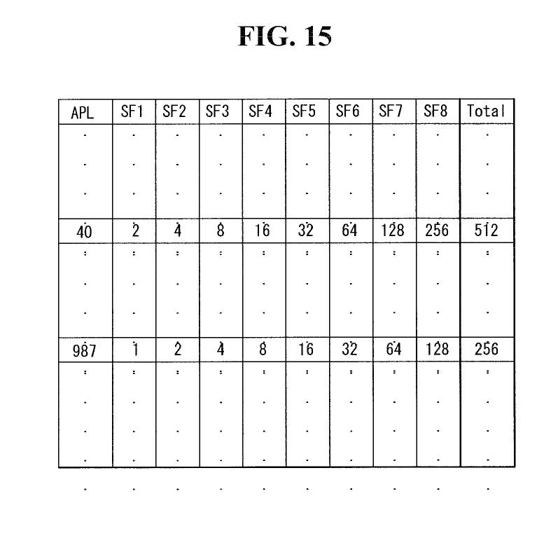

A Table of FIG. 15 is used to set the number of sustain signals assigned to each subfield of a frame and the total number of sustain signals of the frame depending on an APL of the frame. The table is arbitrary made, and the exemplary embodiment is not limited to the table of FIG. 15.

As shown in FIG. 14, a first video signal is input in step S1200. The first video signal is a video signal corresponding to any frame.

Then, the input first video signal is processed through predetermined steps S1210, S1220, and S1230 to output a second video signal in step S1240.

More specifically, the first video signal is input in step S1200, and then a histogram of the first video signal is calculated in step S1210. When the histogram of the first video signal is calculated, an APL of the first video signal is calculated.

A maximum value of the histogram of the first video signal is indicated as a first value R1 and a possible effective value of the histogram of the first video signal is indicated as a second value R2. In step S1220, it is decided whether the first value R1 is or is not smaller than the second value R2.

When the first value R1 is smaller than the second value R2, the number of sustain signals of a corresponding frame is reduced in step S1230.

Subsequently, the second image signal, in which the number of sustain signals is reduced, is output in step S1240.

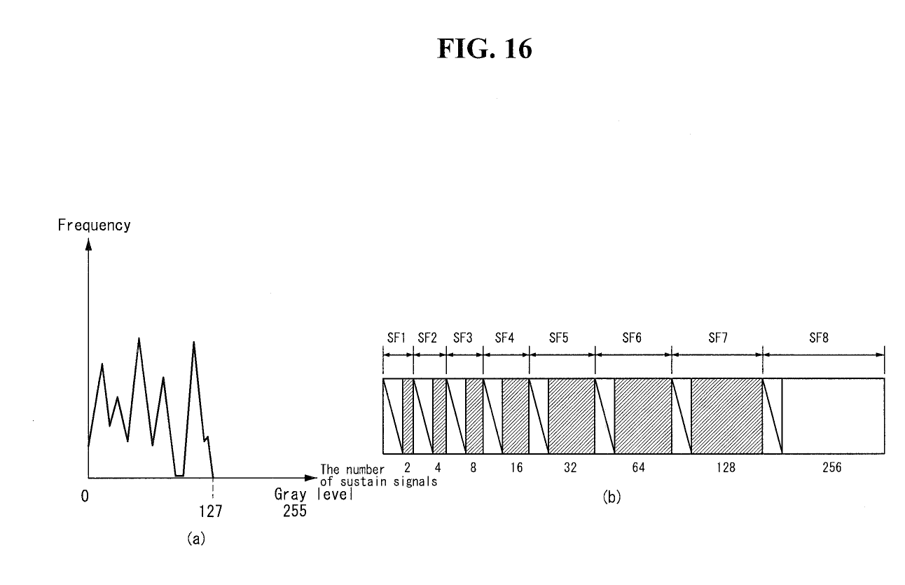

It is assumed that an APL of the first video signal is 40 with reference to FIG. 15, and the first value R1 is 127 and the second value R2 is 255 larger than the first value R1 with reference to FIG. 16.

It is assumed that the first video signal includes a 1-1 video signal and a 1-2 video signal, and the second video signal includes a 2-1 video signal corresponding to the 1-1 video signal and a 2-2 video signal corresponding to the 1-2 video signal. The 1-1 video signal is processed to output the 2-1 video signal, and the 1-2 video signal is processed to output the 2-2 video signal.

In case that a maximum value of a histogram of the 2-2 video signal is smaller than a maximum value of a histogram of the 2-1 video signal, the total number of sustain signals in a frame depending on the 2-2 video signal may be less than the total number of sustain signals in a frame depending on the 2-1 video signal.

Further, the minimum number of sustain signals may analogize in a ratio of the first value R1 to the second value R2. For instance, it is assumed that an APL of the first video signal is 40 and the total number of sustain signals in a frame corresponding to the first video signal is 512 with reference to FIG. 15.

The ratio R1/R2 of the first value R1 to the second value R2 is approximately 127/255. Hence, the minimum number of sustain signals may be set at 256 (=512×(R1/R2)).

Then, 256 sustain signals can be uniformly assigned to subfields. For instance, a predetermined number of sustain signals are assigned to each subfield in the same manner as an APL of 987 in FIG. 15 under condition that a total of 256 sustain signals are assigned to a frame.

The following Equation 1 may be used to set the number of sustain signals assigned to each subfield.

N2≈N1×(R134 R2) [Equation 1]

In the above Equation 1, N1 indicates the number of sustain signals corresponding to the first video signal, R1 indicates the maximum value (i.e., the first value) of the histogram of the first video sign, R2 indicates the possible effective value (i.e., the second value) of the histogram of the first video signal, and N2 indicates the number of sustain signals corresponding to the second video signal.

When the first value R1 is smaller than the second value R2, N2 may be substantially equal to N1×(R1+R2).

In case that sustain signals are assigned to each subfield depending on an APL of 40, the eighth subfield SF8 to which 255 sustain signals are assigned may be an OFF-subfield as shown in (b) of FIG. 16. In other words, in case that the APL is 40, a total of 256 sustain signals are assigned to the first to seventh subfields SF1 to SF7 and 256 sustain signals are assigned to the eighth subfield SF8 so as to achieve 256 gray levels. However, because the eighth subfield SF8 is turned off, the reactive power consumption may increase due to the 256 sustain signals.

If an APL (i.e., an APL of 987 with reference to FIG. 15) in which a total of 256 sustain signals are used is reset so as to prevent an increase in the reactive power consumption, the first to eighth subfields are turned on to achieve 256 gray levels. Hence, the reactive power consumption can be reduced.

A data gain of the second video signal may be substantially equal to the ratio R2/R1 so as to maintain a luminance of the second video signal. For instance, if the first video signal of FIG. 16 is input, a gray level of the first video signal is approximately 127 (=1+2+4+8+16+32+64) and the total number of sustain signals is 512.

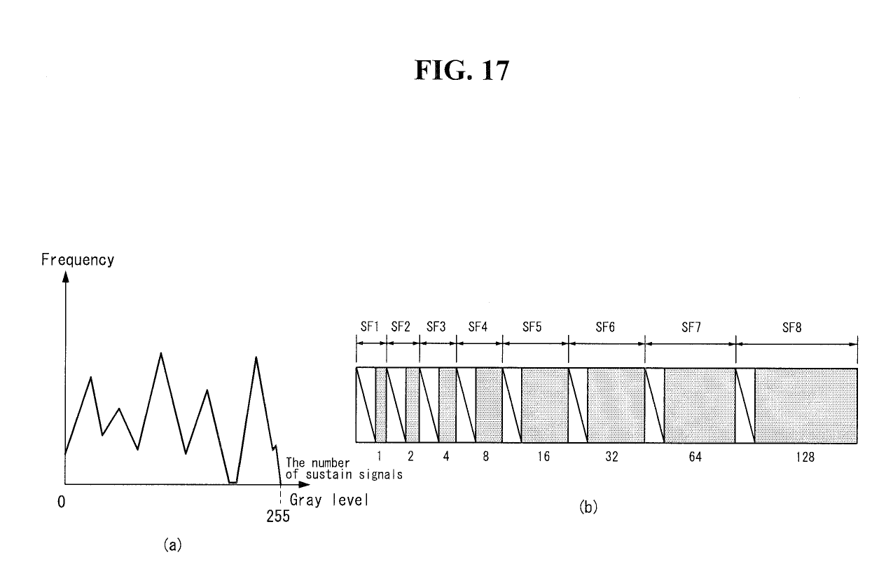

It is assumed that the second video signal with 127 gray levels is output by processing the first video signal with 127 gray levels and assigning a total of 256 sustain signals to the subfields as shown in (b) of FIG. 17. The first to seventh subfields have to be turned on in (b) of FIG. 17 so as to output the second video signal with 127 gray levels. In this case, while the first and second video signals have a substantially equal gray level (i.e., 127 gray levels), the number of sustain signals assigned to the second video signal is reduced to approximately one half of the number of sustain signals assigned to the first video signal.

Accordingly, the first to eighth subfields have to be turned on in (b) of FIG. 17 so that a luminance of the first video signal is substantially equal to a luminance of the second video signal. A gray level of the second video signal output by processing the first video signal with 127 gray levels has to be two times 127 gray levels. For this, it is advantageous that the data gain of the second video signal is set to be substantially equal to the ratio R2/R1.

As above, a maximum value of a histogram of the second video signal can be extended from 127 to 255 as shown in (a) of FIG. 17 by setting the data gain of the second video signal to be substantially equal to the ratio R2/R1.

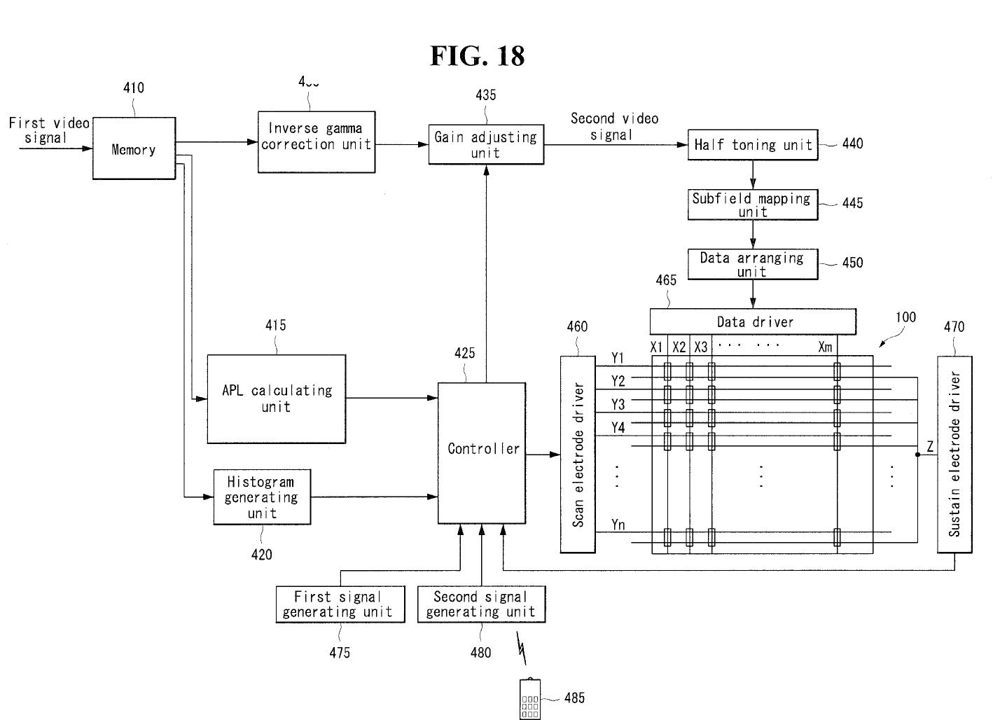

FIG. 18 is a diagram showing in detail a configuration of the plasma display apparatus. In FIG. 18, the driver of FIG. 1 includes a scan electrode driver 460, a sustain electrode driver 470, and a data driver 465.

As shown in FIG. 18, the plasma display apparatus may include a memory 410, an APL calculating unit 415, a histogram generating unit 420, a controller 425, an inverse gamma correction unit 430, a gain adjusting unit 435, a half toning unit 440, a subfield mapping unit 445, a data arranging unit 450, the plasma display panel 100, the scan electrode driver 460, the data driver 465, the sustain electrode driver 470, a first signal generating unit 475, and a second signal generating unit 480. A reference numeral 485 indicates a remote controller.

The memory 410 may store first video data of a first video signal input from the outside.

The APL calculating unit 415 may calculate an APL of the first video signal. In other words, the APL calculating unit 415 may receive the first video data of the first video signal stored in the memory 410 to calculate the APL of the first video signal.

The histogram generating unit 420 may count the frequency of each gray level through the first video data of the first video signal to output histogram data.

The controller 425 may assign the number of sustain signals to the electrodes of the plasma display panel 100 depending on the APL of the first video signal obtained from the APL calculating unit 415. Further, the controller 425 may store a table (for example, the table of FIG. 13) in which the number of sustain signals to be assigned to each subfield depending on the APL is defined.

The controller 425 may assign the number of sustain signals corresponding to the APL of the first video signal input using the table. The controller 425 receives the histogram data from the histogram generating unit 420 to calculate a data gain. The data gain may be substantially equal to a ratio R2/R1 of a representable maximum gray level to a reference gray level.

The controller 425 may reassign the number of sustain signals using a value obtained by dividing the number of sustain signals assigned depending on the APL of the first video signal by the data gain.

The controller 425 adds a predetermined number of sustain signals to the reassigned number of sustain signals, and thus can increase the entire luminance of an image displayed by a second video signal. The added number of sustain signals may be smaller than a difference between the number of sustain signals corresponding to a frame of the first video signal and the number of sustain signals corresponding to a frame of the second video signal. For instance, if the number of sustain signals corresponding to the frame of the first video signal is 510 and the number of sustain signals corresponding to the frame of the second video signal is 255, the added number of sustain signals may be smaller than 255 (=510-255).

The inverse gamma correction unit 430 may perform an inverse gamma correction process on the first video signal.

The gain adjusting unit 435 may receive the gain from the controller 425 to output the second video signal by multiplying the gain by data of the first video signal. The gain adjusting unit 435 may fix a gray level larger than a representable maximum gray level among gray levels of the second video signal as a representable maximum gray level.

The half toning unit 440 may perform an error diffusion process and a dithering process on the second video signal.

The subfield mapping unit 445 may perform a subfield mapping process on the second video signal output from the half toning unit 440 to output subfield mapping data of the second video signal. When the subfield mapping unit 445 performs the subfield mapping process on the second video signal, the second video signal can be mapped to all of subfields of the frame of the second video signal.

The data arranging unit 450 may receive the subfield mapping data of the second video signal output from the subfield mapping unit 445 and rearrange the subfield mapping data in each subfield to output video data corresponding to the second video signal.

The scan electrode driver 460 may supply a reset signal for making a state of wall charges distributed in the discharge cells uniform to the scan electrodes Y1 to Yn under the control of the controller 425 during a reset period of each subfield. The scan electrode driver 460 may supply a scan signal for selecting the discharge cells to emit light to the scan electrodes Y1 to Yn during an address period of each subfield. The scan electrode driver 460 may supply a predetermined number of sustain signals assigned by the controller 425 to the scan electrodes Y1 to Yn during a sustain period of each subfield. In this case, the controller 425 may control the supply timing of sustain signals.

The data driver 465 may supply a data signal corresponding to the video data output from the data arranging unit 450 in synchronization with the scan signal supplied by the scan electrode driver 460 to the address electrodes X1 to Xm during the address period.

The sustain electrode driver 470 may supply a predetermined number of sustain signals assigned by the controller 425 to the sustain electrodes Z during the sustain period. In this case, the controller 425 may control the supply timing of sustain signals.

The controller 425 may an input unit (not shown) that receives a signal (i.e., a gain changing signal) for demanding changes in the gain from the outside. The input unit may be pins of the controller 425.

For instance, the controller 425 may receive the gain changing signal from the first signal generating unit 475 including a key pad or the second signal generating unit 480 including a radio signal receiver. In other words, the first signal generating unit 475 may output a first set signal for setting the reference gray level or the gain to the controller 425.

The second signal generating unit 480 may output a second set signal for setting the reference gray level or the gain to the controller 425. The second signal generating unit 480 may output the second set signal corresponding to a radio signal received from the remote controller 485 to the controller 425.

The controller 425 receiving the set signal output from at least one of the first signal generating unit 475 or the second signal generating unit 480 may renew the reference gray level or the gain. As an example, an user controls the first signal generating unit 475 or the remote controller 485 so as to set the reference gray level at 120, and thus the first signal generating unit 475 can output the first set signal to the controller 425 and the second signal generating unit 480 can receive the radio signal to output the second set signal to the controller 425. The controller 425 renews the reference gray level from 127 to 120, and again calculates the gain depending on the renewed reference gray level to output the recalculated gain to the gain adjusting unit 435. The gain adjusting unit 435 can output the second video signal by multiplying the first video signal by the renewed gain of 2.5.

As another example, the user controls the first signal generating unit 475 or the remote controller 485 so as to set the gain at 2.5, and thus the first signal generating unit 475 can output the first set signal to the controller 425 and the second signal generating unit 480 can receive the radio signal to output the second set signal to the controller 425. The controller 425 renews the set gain of 2.0 to 2.5 and outputs the renewed gain of 2.5 to the gain adjusting unit 435. The gain adjusting unit 435 can output the second video signal by multiplying the first video signal by the renewed gain of 2.5.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. A method of driving a plasma display apparatus displaying an image in a frame including a plurality of subfields, the method comprising:
controlling the number of sustain signals assigned to at least one of the plurality of subfields of the frame depending on an average power level (APL) of the frame; and
additionally controlling the number of sustain signals assigned depending on the APL in relation to a maximum gray level of the frame.

2. The method of claim 1, wherein the maximum gray level of the frame lies in a range between a lowest subfield weight of the frame and a sum of subfield weights of the plurality of subfields of the frame.

3. The method of claim 1, wherein when the maximum gray level of the frame is equal to a sum of subfield weights of the plurality of subfields of the frame, the number of sustain signals assigned depending on the APL is maintained.

4. The method of claim 1, wherein when the maximum gray level of the frame is smaller than a sum of subfield weights of the plurality of subfields of the frame, the number of sustain signals assigned depending on the APL is reduced.

5. The method of claim 4, wherein when the maximum gray level of the frame is smaller than the sum of the subfield weights of the plurality of subfields of the frame, the number of sustain signals assigned depending on the APL is reduced in a ratio of the maximum gray level of the frame to the sum of the subfield weights of the plurality of subfields of the frame.

6. The method of claim 4, wherein when the maximum gray level of the frame is smaller than the sum of the subfield weights of the plurality of subfields of the frame, a gain increases.

7. The method of claim 4, wherein when the maximum gray level of the frame is smaller than the sum of the subfield weights of the plurality of subfields of the frame, a gain increases in a ratio of the sum of the subfield weights of the plurality of subfields of the frame to the maximum gray level of the frame.

8. A plasma display apparatus comprising:
a plasma display panel displaying an image in a plurality of frames each including a plurality of subfields, the plasma display panel including an electrode; and
a driver supplying a sustain signal to the electrode,
wherein the plurality of frames include a first frame and a second frame,
an average power level (APL) of the first frame is substantially equal to an APL of the second frame, and a maximum gray level of the first frame is different from a maximum gray level of the second frame, and
the total number of sustain signals supplied to the electrode in the first frame is different from the total number of sustain signals supplied to the electrode in the second frame.

9. The plasma display apparatus of claim 8, wherein the maximum gray level of the second frame is lower than the maximum gray level of the first frame, and the total number of sustain signals supplied to the electrode in the second frame is less than the total number of sustain signals supplied to the electrode in the first frame.

10. The plasma display apparatus of claim 9, wherein in case that the maximum gray level of the first frame is a gray level corresponding to substantially full-white and the maximum gray level of the second frame is a gray level corresponding to substantially full-black, the total number of sustain signals supplied to the electrode in the second frame lies substantially in a range between 2% and 30% of the total number of sustain signals supplied to the electrode in the first frame.

11. The plasma display apparatus of claim 8, wherein a maximum gray level of the frame is selectively set at a predetermined gray level lower than a maximum gray level of a plurality of gray levels of video data.

12. The plasma display apparatus of claim 8, wherein in case that a maximum gray level of the frame is A-gray level and the frequency in use of A-gray level is equal to or less than a first critical value based on the frequency of each gray level of the frame, the maximum gray level of the frame is set at B-gray level lower than A-gray level.

13. The plasma display apparatus of claim 12, wherein the first critical value lies substantially in a range between 0.01% and 5% based on the frequency of each gray level of the frame.

14. A plasma display apparatus comprising:
a plasma display panel displaying an image in a plurality of frames each including a plurality of subfields, the plasma display panel including an electrode; and
a driver supplying a sustain signal to the electrode,
wherein the plurality of frames include a first frame and a second frame,
an average power level (APL) of the first frame is substantially equal to an APL of the second frame, and a maximum gray level of the first frame is different from a maximum gray level of the second frame, and
in case that the maximum gray levels of the first and second frames are equal to or more than a critical gray level, a data signal is supplied to the electrode during address periods of all of subfields of the first frame at the maximum gray level of the first frame, and a data signal is supplied to the electrode during address periods of all of subfields of the second frame at the maximum gray level of the second frame.

15. The plasma display apparatus of claim 14, wherein the total number of sustain signals supplied to the electrode in the first frame is different from the total number of sustain signals supplied to the electrode in the second frame.

16. The plasma display apparatus of claim 15, wherein the maximum gray level of the second frame is lower than the maximum gray level of the first frame, and the total number of sustain signals supplied to the electrode in the second frame is less than the total number of sustain signals supplied to the electrode in the first frame.

17. The plasma display apparatus of claim 14, wherein the critical gray level lies substantially in a range between 1% and 25% from a lowest gray level of the entire gray level range.

18. The plasma display apparatus of claim 14, wherein in case that the maximum gray levels of the first and second frames are less than the critical gray level, the total number of sustain signals supplied to the electrode in the first frame is substantially equal to the total number of sustain signals supplied to the electrode in the second frame.

19. The plasma display apparatus of claim 18, wherein the total number of sustain signals supplied to the electrode in each of the first and second frames when the maximum gray levels of the first and second frames are a gray level corresponding to substantially full-black lies substantially in a range between 2% and 30% of the total number of sustain signals supplied to the electrode when the maximum gray level of the first or second frame is a gray level corresponding to substantially full-white.

20. The plasma display apparatus of claim 14, wherein in case that a maximum gray level of the frame is A-gray level and the frequency in use of A-gray level is equal to or less than a critical value based on the frequency of each gray level of the frame, the maximum gray level of the frame is set at B-gray level lower than A-gray level.
